(19) United States
(12) Patent Application Publication
(10) Pub. No.: US 2022/0319150 A1
(43) Pub. Date: Oct. 6, 2022

(54) REGULARITY MEASUREMENT SYSTEM AND METHOD FOR SEAT ARRANGEMENT

(71) Applicant: Ningbo Juzhong Machinery Co., Ltd., Ningbo (CN)

(72) Inventor: Aili Zhou, Hunan (CN)

(21) Appl. No.: 17/419,977

(22) PCT Filed: Aug. 18, 2020
(86) PCT No.: PCT/CN2020/109747

§ 371 Date: Jun. 30, 2021

(30) Foreign Application Priority Data
Jul. 6, 2020 (CN) 202010641043.3

(51) Int. Cl. G06V 10/764; G06T 7/50; G06V 20/64

(52) U.S. Cl. CPC G06V 10/764; G06T 7/50; G06V 20/64

(57) ABSTRACT

The present invention relates to a regularity measurement system and method for seat arrangement, the regularity measurement system includes: a content capturing mechanism, which is located on the casing of a mobile terminal, and is used for performing image content capturing actions on the layout scene of a conference room facing it, so as to obtain the corresponding layout scene image, wherein the content capturing mechanism of the mobile terminal is facing to the center position of the conference table to be analyzed; a classification and recognition device, which is used for matching the layout scene image with the shape of each type of reference seat to obtain the image area where each seat object in the layout scene image is located and the corresponding seat type. The seat arrangement regularity measurement system and method of the present invention are reasonably designed and widely used.

### TECHNICAL FIELD

The present invention relates to the field of conference arrangement, and in particular to a system and method for measuring the regularity of seat arrangement.

### BACKGROUND ART

The conference venue is a specific place for the conference organizer and conference participants to conduct discussion, research, exchange of information, communication of ideas and achieve the purpose of conference transactions.

When arranging the conference venue, the air needs to be properly treated so that the indoor temperature, relative humidity, cleanliness, airflow speed and other indicators can be maintained within a certain range in order to meet the requirements of indoor air environment in office, conference, banquet and other activities. Requirements for air conditioning in conference venues: temperature requirements: the average temperature in conference venues is 22° C., and the adjustment range is ±4° C. (above 18° C. in winter, and below 26° C. in summer); humidity requirements: humidity adjustment accuracy requirements are not very high, generally the average humidity is 50%, and the adjustment range is ±20%, preferably between 30% and 70%.

The requirements and selection of lighting for conference venues are as follows: uniform illuminance, soft and stable lighting, easy to control and adjust. If the brightness is uneven, when the eye sights are transferred from one surface to another, the pupils of the eyes need to be adjusted, which can easily cause visual fatigue.

### SUMMARY OF THE INVENTION

In order to solve the technical problems in the related fields, the present invention provides a regularity measurement system and method for seat arrangement, which can collaboratively determine whether the seats in a conference room need to be rearranged basing on different related parameters of the seat distribution in the conference room, thereby quickly and conveniently provide reference data for conference layout, avoiding errors caused by manual visual judgment.

To this end, the present invention needs to have the following three key invention aspects:

(1) Calculate the regularity of the seat arrangement in a conference room basing on the degree of repetition of the seat types in the conference room and the degree of variation in the arrangement interval of the seats, so as to trigger the seat rearrangement instruction and execute operation when the seat arrangement is not neat enough;

(2) The higher the degree of repetition of the seat types in the conference room, the higher the regularity of the seat arrangement in the corresponding conference room obtained by calculation;

(3) The higher in variation in the arrangement interval of the seats in the conference room, the lower the regularity of the seats in the corresponding conference room obtained by calculation.

According to an aspect of the present invention, a regularity measurement system for seat arrangement is provided, which includes:

a content capturing mechanism, which is located on the casing of a mobile terminal, and is used for performing image content capturing actions on the layout scene of a conference room facing it, so as to obtain the corresponding layout scene image, wherein the content capturing mechanism of the mobile terminal is facing to the center position of the conference table to be analyzed;

a classification and recognition device, which is arranged inside the mobile terminal, connected to the content capturing mechanism, and is used for matching the layout scene image with the shape of each type of reference seat to obtain the image area where each seat object in the layout scene image is located and the corresponding seat type;

a signal detection device, which is connected to the classification and recognition device, and is used to detect the real-time depth of field of each seat object in the layout scene image;

a first analysis device, which is connected to the classification and recognition device, and is configured to count the repetition degree of the seat type in the layout scene image basing on the respective seat types corresponding to the received seat objects;

a second analysis device, which is connected to the signal detection device, and is used to calculate the uniformity of the distribution of the seat objects basing on the respective real-time depths of field corresponding to the received seat objects;

an instruction acquisition device, which is respectively connected to the first analysis device and the second analysis device, and is configured to determine whether to trigger a seat rearrangement instruction basing on the received uniformity of the distribution of seat objects and the degree of repetition of the seat type;

wherein, counting the repetition degree of the seat type in the layout scene image basing on the respective seat types corresponding to each seat object received includes: the fewer the seat types after de-duplication processing in the layout scene image, the higher the repeatability value;

wherein, calculating the uniformity of the distribution of seat objects basing on the respective real-time depth of field corresponding to each received seat object includes: sorting each real-time depth of field from shallow to deep, and calculating the difference between two similar real-time depths of field to obtain multiple depth differences, and determining the corresponding uniformity of the distribution basing on the magnitude of the mean square error of the multiple field depth differences;

wherein, determining whether to trigger a seat rearrangement instruction basing on the received uniformity of the seat object distribution and the repetition of the seat type includes: determining the corresponding rearrangement reference value basing on the received uniformity of the seat object distribution and the repetition of the seat type, wherein the higher the uniformity of the received seat object distribution, the smaller the corresponding rearrangement reference value, and the higher the repetition of the received seat type, the smaller the corresponding rearrangement reference value;

wherein, determining whether to trigger the seat rearrangement instruction basing on the received seat object distribution uniformity and the seat type repetition further includes:

triggering the seat rearrangement instruction when the determined rearrangement reference value is greater than a preset reference value threshold;

wherein, determining the corresponding degree of uniformity of distribution basing on the magnitude of the mean square error of the multiple field depth differences includes: the larger the mean square error, the lower the corresponding degree of uniformity of distribution.

According to another aspect of the present invention, a method for measuring the regularity of seat arrangement is further provided, and the method includes:

using the content capturing mechanism, which is located on the casing of a mobile terminal, and is used for performing image content capturing actions on the layout scene of a conference room facing it, so as to obtain the corresponding layout scene image, wherein the content capturing mechanism of the mobile terminal is facing to the center position of the conference table to be analyzed;

using the classification and recognition device, which is arranged inside the mobile terminal, connected to the content capturing mechanism, and is used for matching the layout scene image with the shape of each type of reference seat to obtain the image area where each seat object in the layout scene image is located and the corresponding seat type;

using the signal detection device, which is connected to the classification and recognition device, and is used to detect the real-time depth of field of each seat object in the layout scene image;

using the first analysis device, which is connected to the classification and recognition device, and is configured to count the repetition degree of the seat type in the layout scene image basing on the respective seat types corresponding to the received seat objects;

using the second analysis device, which is connected to the signal detection device, and is used to calculate the uniformity of the distribution of the seat objects basing on the respective real-time depths of field corresponding to the received seat objects;

using the instruction acquisition device, which is respectively connected to the first analysis device and the second analysis device, and is configured to determine whether to trigger a seat rearrangement instruction basing on the received uniformity of the distribution of seat objects and the degree of repetition of the seat type;

wherein, counting the repetition degree of the seat type in the layout scene image basing on the respective seat types corresponding to each seat object received includes: the fewer the seat types after de-duplication processing in the layout scene image, the higher the repeatability value;

wherein, calculating the uniformity of the distribution of seat objects basing on the respective real-time depth of field corresponding to each received seat object includes: sorting each real-time depth of field from shallow to deep, and calculating the difference between two similar real-time depths of field to obtain multiple depth differences, and determining the corresponding uniformity of the distribution basing on the magnitude of the mean square error of the multiple field depth differences;

wherein, determining whether to trigger a seat rearrangement instruction basing on the received uniformity of the seat object distribution and the repetition of the seat type includes: determining the corresponding rearrangement reference value basing on the received uniformity of the seat object distribution and the repetition of the seat type, wherein the higher the uniformity of the received seat object distribution, the smaller the corresponding rearrangement reference value, and the higher the repetition of the received seat type, the smaller the corresponding rearrangement reference value;

wherein, determining whether to trigger the seat rearrangement instruction basing on the received seat object distribution uniformity and the seat type repetition further includes: triggering the seat rearrangement instruction when the determined rearrangement reference value is greater than a preset reference value threshold;

wherein, determining the corresponding degree of uniformity of distribution basing on the magnitude of the mean square error of the multiple field depth differences includes: the larger the mean square error, the lower the corresponding degree of uniformity of distribution.

The seat arrangement regularity measurement system and method of the present invention are reasonably designed and widely used. Since it can collaboratively judge whether the seats in a conference room need to be rearranged by basing on different related parameters of the seat distribution in the conference room, the reference data of the conference layout can be given quickly and conveniently.

### DESCRIPTION OF ACCOMPANIED FIGURE

The embodiments of the present invention will be described below with reference to the accompanying figure, wherein:

FIG. 1 is a schematic diagram of an application environment of a regularity measurement system for seat arrangement according to an embodiment of the present invention.

### DETAILED IMPLEMENTATION METHOD

Hereinafter, the embodiments of the regularity measurement system and method for seat arrangement of the present invention will be described in detail with reference to the accompanying figure.

In the layout of a conference, the podium needs to be spatial enough to hold water cups, writing stationery, laser pens, etc., and the podium must be of moderate height. The aisle leading to the podium should be illuminated, and the center of the podium should have the name of the conference and the name of the conference center or conference hotel. Adjust the microphone volume beforehand, and the volume should not be too loud; It is necessary to equipped with audio-visual equipment, such as computers, projectors, video recorders, screens, audio equipment, laser pointers, free mail services, DVD air-conditioning, lighting, etc.; Cleanliness requirements are as follows: refers to dust concentration in the air and air cleanliness levels are divided as follows: the average number of dust particles of 0.5 micron per liter of air does not exceed 300, which is called class 300 cleanliness; the average number of dust particles of 0.5 micron per liter of air does not exceed 3,000 particles, and this is called class 3,000 cleanliness; the average number of dust particles of 0.5 microns per liter of air does not exceed 30,000, which is called class 30,000 cleanliness. The cleanliness of air conditioners with general comfort should be around 30,000; Conference video systems such as video recorders, projectors, slide projectors, video special effects device, cameras and other major equipment, as well as video switchers, video distributors, format converters, etc. shall be provided; When necessary, simultaneous broadcasting and voting systems are required.

However, in the conference arrangement in the prior art, it is impossible to collaboratively judge whether the seats in a conference room need to be rearranged by basing on the different related parameters of the seat distribution in the conference room, which make it impossible to quickly and conveniently provides reference data for the conference arrangement to avoid errors caused by manual visual judgment.

In order to overcome the above shortcomings, the present invention builds a regularity measurement system and method for seat arrangement, which can effectively solve the corresponding technical problems.

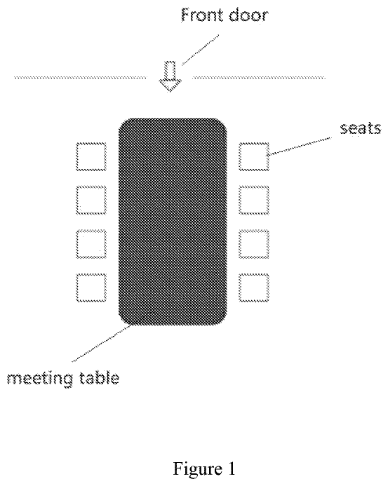

FIG. 1 is a schematic diagram of an application environment of a regularity measurement system for seat arrangement according to an embodiment of the present invention, and the system includes:

a content capturing mechanism, which is located on the casing of a mobile terminal, and is used for performing image content capturing actions on the layout scene of a conference room facing it, so as to obtain the corresponding layout scene image, wherein the content capturing mechanism of the mobile terminal is facing to the center position of the conference table to be analyzed;

a classification and recognition device, which is arranged inside the mobile terminal, connected to the content capturing mechanism, and is used for matching the layout scene image with the shape of each type of reference seat to obtain the image area where each seat object in the layout scene image is located and the corresponding seat type;

a signal detection device, which is connected to the classification and recognition device, and is used to detect the real-time depth of field of each seat object in the layout scene image;

a first analysis device, which is connected to the classification and recognition device, and is configured to count the repetition degree of the seat type in the layout scene image basing on the respective seat types corresponding to the received seat objects;

a second analysis device, which is connected to the signal detection device, and is used to calculate the uniformity of the distribution of the seat objects basing on the respective real-time depths of field corresponding to the received seat objects;

an instruction acquisition device, which is respectively connected to the first analysis device and the second analysis device, and is configured to determine whether to trigger a seat rearrangement instruction basing on the received uniformity of the distribution of seat objects and the degree of repetition of the seat type;

wherein, counting the repetition degree of the seat type in the layout scene image basing on the respective seat types corresponding to each seat object received includes: the fewer the seat types after de-duplication processing in the layout scene image, the higher the repeatability value;

wherein, calculating the uniformity of the distribution of seat objects basing on the respective real-time depth of field corresponding to each received seat object includes: sorting each real-time depth of field from shallow to deep, and calculating the difference between two similar real-time depths of field to obtain multiple depth differences, and determining the corresponding uniformity of the distribution basing on the magnitude of the mean square error of the multiple field depth differences;

wherein, determining whether to trigger a seat rearrangement instruction basing on the received uniformity of the seat object distribution and the repetition of the seat type includes: determining the corresponding rearrangement reference value basing on the received uniformity of the seat object distribution and the repetition of the seat type, wherein the higher the uniformity of the received seat object distribution, the smaller the corresponding rearrangement reference value, and the higher the repetition of the received seat type, the smaller the corresponding rearrangement reference value;

wherein, determining whether to trigger the seat rearrangement instruction basing on the received seat object distribution uniformity and the seat type repetition further includes: triggering the seat rearrangement instruction when the determined rearrangement reference value is greater than a preset reference value threshold;

wherein, determining the corresponding degree of uniformity of distribution basing on the magnitude of the mean square error of the multiple field depth differences includes: the larger the mean square error, the lower the corresponding degree of uniformity of distribution.

Next, the specific structure of the regularity measurement system for seat arrangement of the present invention will be further explained.

The regularity measurement system for seat arrangement may further includes:

an on-site display device, which is located on the casing of the mobile terminal, and is respectively connected with the instruction acquisition device, the first analysis device and the second analysis device.

In the regularity measurement system for seat arrangement:

the on-site display device is used to receive and display the uniformity of the distribution of the seat objects, the degree of repetition of the seat types, and the determined corresponding rearrangement reference value.

The regularity measurement system for seat arrangement further comprises:

a user input device, which is located on the casing of the mobile terminal, and is used to receive the preset reference value threshold input by the user according to the current operation of the user.

In the regularity measurement system for seat arrangement:

the on-site display device is also configured to perform a display operation of text warning information corresponding to the rearrangement of seats after receiving the seat rearrangement instruction.

According to the present invention, a method for measuring the regularity of seat arrangement is further provided, which includes:

using the content capturing mechanism, which is located on the casing of a mobile terminal, and is used for performing image content capturing actions on the layout scene of a conference room facing it, so as to obtain the corresponding layout scene image, wherein the content capturing mechanism of the mobile terminal is facing to the center position of the conference table to be analyzed;

using the classification and recognition device, which is arranged inside the mobile terminal, connected to the content capturing mechanism, and is used for matching the layout scene image with the shape of each type of reference seat to obtain the image area where each seat object in the layout scene image is located and the corresponding seat type;

using the signal detection device, which is connected to the classification and recognition device, and is used to detect the real-time depth of field of each seat object in the layout scene image;

using the first analysis device, which is connected to the classification and recognition device, and is configured to count the repetition degree of the seat type in the layout scene image basing on the respective seat types corresponding to the received seat objects;

using the second analysis device, which is connected to the signal detection device, and is used to calculate the uniformity of the distribution of the seat objects basing on the respective real-time depths of field corresponding to the received seat objects;

using the instruction acquisition device, which is respectively connected to the first analysis device and the second analysis device, and is configured to determine whether to trigger a seat rearrangement instruction basing on the received uniformity of the distribution of seat objects and the degree of repetition of the seat type;

wherein, counting the repetition degree of the seat type in the layout scene image basing on the respective seat types corresponding to each seat object received includes: the fewer the seat types after de-duplication processing in the layout scene image, the higher the repeatability value;

wherein, calculating the uniformity of the distribution of seat objects basing on the respective real-time depth of field corresponding to each received seat object includes: sorting each real-time depth of field from shallow to deep, and calculating the difference between two similar real-time depths of field to obtain multiple depth differences, and determining the corresponding uniformity of the distribution basing on the magnitude of the mean square error of the multiple field depth differences;

wherein, determining whether to trigger a seat rearrangement instruction basing on the received uniformity of the seat object distribution and the repetition of the seat type includes: determining the corresponding rearrangement reference value basing on the received uniformity of the seat object distribution and the repetition of the seat type, wherein the higher the uniformity of the received seat object distribution, the smaller the corresponding rearrangement reference value, and the higher the repetition of the received seat type, the smaller the corresponding rearrangement reference value;

wherein, determining whether to trigger the seat rearrangement instruction basing on the received seat object distribution uniformity and the seat type repetition further includes: triggering the seat rearrangement instruction when the determined rearrangement reference value is greater than a preset reference value threshold;

wherein, determining the corresponding degree of uniformity of distribution basing on the magnitude of the mean square error of the multiple field depth differences includes: the larger the mean square error, the lower the corresponding degree of uniformity of distribution.

Next, the specific steps of the regularity measurement method for seat arrangement of the present invention will be further described.

The regularity measurement method for seat arrangement may further includes:

using the on-site display device, which is located on the casing of the mobile terminal, and is respectively connected with the instruction acquisition device, the first analysis device and the second analysis device.

In the method for measuring the regularity of seat arrangement:

the on-site display device is used to receive and display the uniformity of the distribution of the seat objects, the degree of repetition of the seat types, and the determined corresponding rearrangement reference value.

The method for measuring the regularity of seat arrangement further includes:

using the user input device, which is located on the casing of the mobile terminal, and is used to receive the preset reference value threshold input by the user according to the current operation of the user.

In the method for measuring the regularity of seat arrangement:

the on-site display device is also configured to perform a display operation of text warning information corresponding to the rearrangement of seats after receiving the seat rearrangement instruction.

In addition, the content capturing mechanism has a built-in passive pixel sensor for performing corresponding image sensing operations.

Passive Pixel Sensors (PPS) consists of a reverse-biased photodiode and a switch tube. The photodiode is essentially a PN junction composed of a P-type semiconductor and an N-type semiconductor, which can be equivalent to a reverse-biased diode and a MOS capacitor in parallel. When the switch tube is turned on, the photodiode is connected to the vertical column bus. The charge integrating amplifier readout circuit at the end of the column line keeps the column line voltage constant. When the signal charge stored by the photodiode is read out, its voltage is reset to the column line voltage level, and at the same time, the charge proportional to the optical signal is converted into a charge output by the charge integrating amplifier.

Finally, it should be noted that each functional device in each embodiment of the present invention may be integrated into one processing device, or each device may exist alone physically, or two or more devices may be integrated into one device.

If the function is implemented in the form of a software function device and sold or used as an independent product, it can be stored in a computer readable storage medium. Based on this understanding, the technical solution of the present invention essentially or the part that contributes to the prior art or the part of the technical solution can be embodied in the form of a software product, and the computer software product is stored in a storage medium, including several instructions are used to make a computer device (which may be a personal computer, a server, or a network device, etc.) to execute all or part of the steps of the method described in each embodiment of the present invention. The aforementioned storage media include: U disk, mobile hard disk, read-only memory (ROM), random access memory (RAM), magnetic disks or optical disks and other media that can store program codes.

The above are only specific embodiments of the present invention, but the scope of protection of the present invention is not limited thereto. Any person skilled in the art can easily think of changes or substitutions within the technical scope disclosed by the present invention, and it should be covered within the protection scope of the present invention. Therefore, the protection scope of the present invention should be based on the protection scope of the claims.

What is claimed is:

1. A regularity measurement system for seat arrangement, characterized in that, the system includes:
a content capturing mechanism, which is located on the casing of a mobile terminal, and is used for performing image content capturing actions on the layout scene of a conference room facing it, so as to obtain the corresponding layout scene image, wherein the content capturing mechanism of the mobile terminal is facing to the center position of the conference table to be analyzed;
a classification and recognition device, which is arranged inside the mobile terminal, connected to the content capturing mechanism, and is used for matching the layout scene image with the shape of each type of reference seat to obtain the image area where each seat object in the layout scene image is located and the corresponding seat type;
a signal detection device, which is connected to the classification and recognition device, and is used to detect the real-time depth of field of each seat object in the layout scene image;
a first analysis device, which is connected to the classification and recognition device, and is configured to count the repetition degree of the seat type in the layout scene image basing on the respective seat types corresponding to the received seat objects;
a second analysis device, which is connected to the signal detection device, and is used to calculate the uniformity of the distribution of the seat objects basing on the respective real-time depths of field corresponding to the received seat objects;
an instruction acquisition device, which is respectively connected to the first analysis device and the second analysis device, and is configured to determine whether to trigger a seat rearrangement instruction basing on the received uniformity of the distribution of seat objects and the degree of repetition of the seat type;
wherein, counting the repetition degree of the seat type in the layout scene image basing on the respective seat types corresponding to each seat object received includes: the fewer the seat types after de-duplication processing in the layout scene image, the higher the repeatability value;
wherein, calculating the uniformity of the distribution of seat objects basing on the respective real-time depth of field corresponding to each received seat object includes: sorting each real-time depth of field from shallow to deep, and calculating the difference between two similar real-time depths of field to obtain multiple depth differences, and determining the corresponding uniformity of the distribution basing on the magnitude of the mean square error of the multiple field depth differences;
wherein, determining whether to trigger a seat rearrangement instruction basing on the received uniformity of the seat object distribution and the repetition of the seat type includes: determining the corresponding rearrangement reference value basing on the received uniformity of the seat object distribution and the repetition of the seat type, wherein the higher the uniformity of the received seat object distribution, the smaller the corresponding rearrangement reference value, and the higher the repetition of the received seat type, the smaller the corresponding rearrangement reference value;
wherein, determining whether to trigger the seat rearrangement instruction basing on the received seat object distribution uniformity and the seat type repetition further includes: triggering the seat rearrangement instruction when the determined rearrangement reference value is greater than a preset reference value threshold;
wherein, determining the corresponding degree of uniformity of distribution basing on the magnitude of the mean square error of the multiple field depth differences includes: the larger the mean square error, the lower the corresponding degree of uniformity of distribution.

2. The regularity measurement system for seat arrangement according to claim 1, characterized in that, the system further comprises:
an on-site display device, which is located on the casing of the mobile terminal, and is respectively connected with the instruction acquisition device, the first analysis device and the second analysis device.

3. The regularity measurement system for seat arrangement according to claim 2, characterized in that:
the on-site display device is used to receive and display the uniformity of the distribution of the seat objects, the degree of repetition of the seat types, and the determined corresponding rearrangement reference value.

4. The regularity measurement system for seat arrangement according to claim 3, characterized in that, the system further comprises:
a user input device, which is located on the casing of the mobile terminal, and is used to receive the preset reference value threshold input by the user according to the current operation of the user.

5. The regularity measurement system for seat arrangement according to claim 4, characterized in that:
the on-site display device is also configured to perform a display operation of text warning information corresponding to the rearrangement of seats after receiving the seat rearrangement instruction.

6. A method for measuring the regularity of seat arrangement, characterized in that, the method includes:
using the content capturing mechanism, which is located on the casing of a mobile terminal, and is used for performing image content capturing actions on the layout scene of a conference room facing it, so as to obtain the corresponding layout scene image, wherein the content capturing mechanism of the mobile terminal is facing to the center position of the conference table to be analyzed;
using the classification and recognition device, which is arranged inside the mobile terminal, connected to the content capturing mechanism, and is used for matching the layout scene image with the shape of each type of reference seat to obtain the image area where each seat object in the layout scene image is located and the corresponding seat type;
using the signal detection device, which is connected to the classification and recognition device, and is used to detect the real-time depth of field of each seat object in the layout scene image;
using the first analysis device, which is connected to the classification and recognition device, and is configured to count the repetition degree of the seat type in the layout scene image basing on the respective seat types corresponding to the received seat objects;
using the second analysis device, which is connected to the signal detection device, and is used to calculate the uniformity of the distribution of the seat objects basing on the respective real-time depths of field corresponding to the received seat objects;
using the instruction acquisition device, which is respectively connected to the first analysis device and the second analysis device, and is configured to determine whether to trigger a seat rearrangement instruction basing on the received uniformity of the distribution of seat objects and the degree of repetition of the seat type;
wherein, counting the repetition degree of the seat type in the layout scene image basing on the respective seat types corresponding to each seat object received includes: the fewer the seat types after de-duplication processing in the layout scene image, the higher the repeatability value;
wherein, calculating the uniformity of the distribution of seat objects basing on the respective real-time depth of field corresponding to each received seat object includes: sorting each real-time depth of field from shallow to deep, and calculating the difference between two similar real-time depths of field to obtain multiple depth differences, and determining the corresponding uniformity of the distribution basing on the magnitude of the mean square error of the multiple field depth differences;
wherein, determining whether to trigger a seat rearrangement instruction basing on the received uniformity of the seat object distribution and the repetition of the seat type includes: determining the corresponding rearrangement reference value basing on the received uniformity of the seat object distribution and the repetition of the seat type, wherein the higher the uniformity of the received seat object distribution, the smaller the corresponding rearrangement reference value, and the higher the repetition of the received seat type, the smaller the corresponding rearrangement reference value;
wherein, determining whether to trigger the seat rearrangement instruction basing on the received seat object distribution uniformity and the seat type repetition further includes: triggering the seat rearrangement instruction when the determined rearrangement reference value is greater than a preset reference value threshold;
wherein, determining the corresponding degree of uniformity of distribution basing on the magnitude of the mean square error of the multiple field depth differences includes: the larger the mean square error, the lower the corresponding degree of uniformity of distribution.

7. The method for measuring the regularity of seat arrangement according to claim 6, characterized in that, the method further includes:
using the on-site display device, which is located on the casing of the mobile terminal, and is respectively connected with the instruction acquisition device, the first analysis device and the second analysis device.

8. The method for measuring the regularity of seat arrangement according to claim 7, characterized in that:
the on-site display device is used to receive and display the uniformity of the distribution of the seat objects, the degree of repetition of the seat types, and the determined corresponding rearrangement reference value.

9. The method for measuring the regularity of seat arrangement according to claim 8, characterized in that, the method further includes:
using the user input device, which is located on the casing of the mobile terminal, and is used to receive the preset reference value threshold input by the user according to the current operation of the user.

10. The method for measuring the regularity of seat arrangement according to claim 9, characterized in that:
the on-site display device is also configured to perform a display operation of text warning information corresponding to the rearrangement of seats after receiving the seat rearrangement instruction.
